(19) United States
(12) Patent Application Publication
(10) Pub. No.: US 2017/0187785 A1
(43) Pub. Date: Jun. 29, 2017

(54) Microservice with decoupled user interface

(71) Applicant: HEWLETT PACKARD ENTERPRISE DEVELOPMENT LP, Houston, TX (US)

(72) Inventors: Christopher Johnson, Fort Collins, CO (US); Stephane Herman Maes, Fremont, CA (US); Woong Kim, Milford, CT (US)

(21) Appl. No.: 14/998,175

(22) Filed: Dec. 23, 2015

(51) Int. Cl. H04L 29/08; H04L 12/58

(52) U.S. Cl. CPC H04L 67/10; H04L 51/22

(57) ABSTRACT

A microservice may be developed comprising application programming interfaces (APIs), a user interface, logic, and data received from at least one backend system, wherein the APIs and the user interface are decoupled from the logic and the at least one backend system, and the user interface, the logic and the data are decomposable into modules that may be shared with a different microservice. The microservice may expose a set of functions sufficient to support a target use case and Recycle management of the microservice, comprising at least one of exposing lifecycle management APIs and providing lifecycle self-management functionality.

### BACKGROUND

Across the information technology (IT) industry, data may be located and processed in complex and distributed environments. In some examples, applications utilize data and/or logic that may be easily changed, evolved, and/or migrated. The source of such applications also may be changed. In this context, developers seek to rapidly and efficiently build new services that utilize legacy applications. Enterprises seek to deploy new services utilizing functions that may duplicate existing legacy applications, and to re-purpose such existing applications, such as for the cloud.

### BRIEF DESCRIPTION OF THE DRAWINGS

FIG. 1 is a schematic diagram of an example arrangement including a microservice and backend systems according to examples of the present disclosure.

FIG. 2 is a schematic block diagram of an example arrangement including microservice servers, microservices, orchestrated message brokers and backend systems according to examples of the present disclosure.

FIG. 3 is a schematic block diagram of an example arrangement including a knowledge microservice and a module of the microservice according to an example of the present disclosure.

FIG. 4 is a schematic diagram of an example arrangement including a microservice, orchestrator, message broker, and backend systems according to examples of the present disclosure.

FIG. 5 is a schematic diagram of an example arrangement including a microservice, backend system and a lifecycle management API according to examples of the present disclosure.

FIG. 6 is a schematic diagram of an example arrangement including a lifecycle management API of an application according to examples of the present disclosure.

FIG. 7 is a block diagram of a non-transitory machine-readable storage medium containing instructions to provide a microservice according to examples of the present disclosure.

FIG. 8 is a block diagram of a non-transitory machine-readable storage medium containing instructions to provide a microservice according to examples of the present disclosure.

FIGS. 9A and 9B are a flow chart of a method for developing a microservice according to an example of the present disclosure.

FIG. 10 is a block diagram of a computer system according to examples of the present disclosure.

### DETAILED DESCRIPTION

The growth of complex and distributed data processing environments across IT industries is posing challenges to traditional methods of extracting value from data. In the face of the increasing size and complexity of data sets coupled with changing regulatory environments, some traditional data processing applications and models are becoming inadequate. At the same time, enterprises are continually seeking to increase operational efficiencies while also reducing costs and risks associated with the location and processing of data.

Examples of businesses facing these challenges include telecom carriers and cloud service providers that perform functions involving personal or financial data, where privacy considerations and related regulations govern data movement. Similar issues may arise in performing functions that may involve providing confidential raw data or high volume data (e.g. input to big data functions). In some examples service providers may decide to either refrain from offering their services in certain geographies or elect to deploy a cloud/data center in the country (e.g. when regulations prevent the data from leaving the country).

In some examples, an Operations Support System (OSS) or Business Support System (BSS) may be deployed locally at the customer's site (in a country) to perform all of the processing tasks locally, with the same application also deployed at an aggregated point to reflect and process the results of these local processes (i.e., a front end at the aggregate level task and the logical backend of an application on premise/in country). However, such applications are often extremely large and unwieldy.

Other approaches may move the data to the location where processing takes place, with results returned to the client. Such approaches may not provide flexibly customized or repurposed solutions. Similarly, some Platform-as-a-Solution (PaaS) solutions attempt to move data (databases) and execution environments close together. However, such approaches may create binding affinities and may not be flexibly customized or repurposed. They also may run afoul of regulations that may, for example, forbid data to cross borders to reach where the processing takes place.

As described in more detail below, the present disclosure includes examples of microservices that include a user interface (UI) that is decoupled from logic and at least one backend system. In some examples a microservice may refer to a Service Oriented Architecture (SOA) service (implemented with program code) that executes a specific function(s) and exposes its capabilities through a functional interface. In the present disclosure, “exposing” capabilities, functionality, interfaces, etc. may be defined as making available such capabilities, functionality, interfaces, etc. to other entities. As described in more detail below, in some examples a microservice may include a UI, application programming interfaces (APIs), such as a Representational State Transfer (REST) APIs or other type of APIs, logic, and data that is received from interactions with backend systems (services and applications) that are involved in implementing a service. In some examples the microservice may interact with such backend services or applications via an orchestrated message broker.

In some examples, a microservice may comprise a service that (1) utilizes an appropriate granularity to expose a set of functions that is useful to group together and manage together (such as, for example, scaling up, scaling down, remediate, etc.) to efficiently support target use cases; and (2) implements the functionality needed for the target use cases and for lifecycle management (or self-management) of the service (such as, for example, UI, access to data sources, and execution environment). In some examples, a microservice may expose lifecycle management APIs to enable external lifecycle management of the microservice and/or provide lifecycle self-management functionality.

In some examples, SOA compositions as well as native cloud applications may include many (potentially hundreds or thousands) of sub-applications (services) that are interconnected. These numerous applications, however, may not be easily managed or self-managed while also being easily changed, evolved and/or migrated without affecting the entire application. Additionally, each service may have its own unique lifecycle that may include operations such as deployment, monitoring, management and remediation including duplication, clustering, moving, scaling up or out, scaling down or in, upgrade and patching, error remediation, and finally decommissioning or replacement. Managing such a lifecycle for one service can be difficult and costly, and when taken in the context of dozens, hundreds or thousands of services, the complexity of the challenge can become orders of magnitude larger.

In the present disclosure and as described in more detail below, by decoupling the UI and APIs from the logic and data sources (backend systems) of a microservice, the location of data processing or performance of functions may be conveniently and easily changed without modifying the implementation of use cases that utilize these functions. In other words, data processing may be performed anywhere without affecting how it is subsequently requested and/or used, and without constraining the performance to a particular location. Additionally, in some examples lifecycle management of an application that forms a portion of a microservice may be provided by exposing a lifecycle management interface as part of the microservice to enable external coordination and control. The lifecycle management interface may include deployment, monitoring, management and remediation including duplication, clustering, moving, scaling up or out, scaling down or in, patching, upgrade and decommission APIs. In some examples, the microservice may include lifecycle self-management functionality.

In some examples, an enterprise may utilize microservices that provide various services, for example services for IT management, as well as other types of services. An “enterprise” may refer to a business concern, an educational organization, a government agency, an individual, or any other entity. Flow logic or simply “logic” may implement workflows that correspond to enterprise processes or use cases and the corresponding applications. Logic may include a representation of a collection of tasks that are to be performed. The logic may be in the form of program code (e.g. a script or other form of machine-executable instructions), a document according to a specified language or structure (e.g., Business Process Execution Language (BPEL), a Business Process Model and Notation (BPMN), etc.), or any other type of representation (e.g., YAML Yet Another Markup Language (YAML), Mistral from OpenStack, etc.). Logic may be stored in a non-transitory machine-readable or computer-readable storage medium.

A “workflow” may refer to any process that an enterprise can perform, such as a use case. An “end-to-end process” refers to a process that involves a number of activities of the enterprise from start to finish. A “use case” may refer to any specific business process or other service implemented by an enterprise. A use case may comprise services or service operations, where a service or service operation may be a self-contained unit of functionality.

An “application” may refer to machine-readable instructions (such as software and/or firmware) that are executable by a processor. An application may be developed by the enterprise or provided by an external vendor of the enterprise. An application may be provided on the premises of the enterprise or remotely (such as in the cloud), and the application may be a hosted application (e.g., an application provided by a provider over a network), a managed service (a service provided by a service provider), or a software as a service (SaaS), and so forth. SaaS may refer to an arrangement in which software (or more generally, machine-executable instructions) is made available to users on a subscription basis. Applications may be from different vendors. In some cases, multiple applications used by the enterprise may be provided by different vendors.

Within a portfolio of applications used by an enterprise, some applications may not be able to directly interact with other applications. In general, an application implements a particular set of business logic and may not be aware of other applications that are responsible for performing other processes. The design of an application may or may not have taken into account the presence of other applications upstream or downstream (with respect to an end-to-end process). This may be especially true for legacy applications that may have been developed earlier in the timeline of an enterprise.

In some examples, applications may expose well defined application programming interfaces (APIs) that assume that the applications will be interacting with other systems. Such applications are called by their APIs or can call other APIs. Even with such APIs, however, applications may not readily interact with each other. For example, different applications may employ different data formats, different languages, different interfaces, different protocols, and so forth. As described in more detail below, examples of the present disclosure may enable an enterprise to utilize microservices that comprise a portfolio of applications that may be easily changed, repurposed and/or managed.

As described in more detail below, in some examples a design pattern of the present disclosure targets reducing the set of functions exposed by a microservice to a minimal set of functions that (1) is sufficient to provide the functionality of target use cases (while other functions may be provided by other microservices or in an application that calls the microservice); and (2) also provides lifecycle management of the microservice. In some examples, a set of functions that is sufficient to provide consistent lifecycle management of a microservice may be defined to include those functions that should be created, scaled, monitored, remediated, terminated, etc. together and in the same way as a part of the same microservice.

Accordingly and in some examples, microservices according to the present disclosure may have an appropriate granularity to expose a set of functions that is useful to group and manage together (e.g., scale up, scale down, remediate, etc.) and that efficiently supports the target use cases. Utilizing a granularity of services and exposed functions that is too large may result in a monolithic service that does not have the agility and resilience of a microservice of the present disclosure. On the other hand, utilizing a granularity that is too small may lead to multiple services that are managed in an inefficient and duplicated manner. Additionally, microservices according to the present disclosure may provide the functionality to support the target use case(s) while also enabling external lifecycle management or lifecycle self-management of the microservice (e.g., UI, access to data sources and execution environment, etc.).

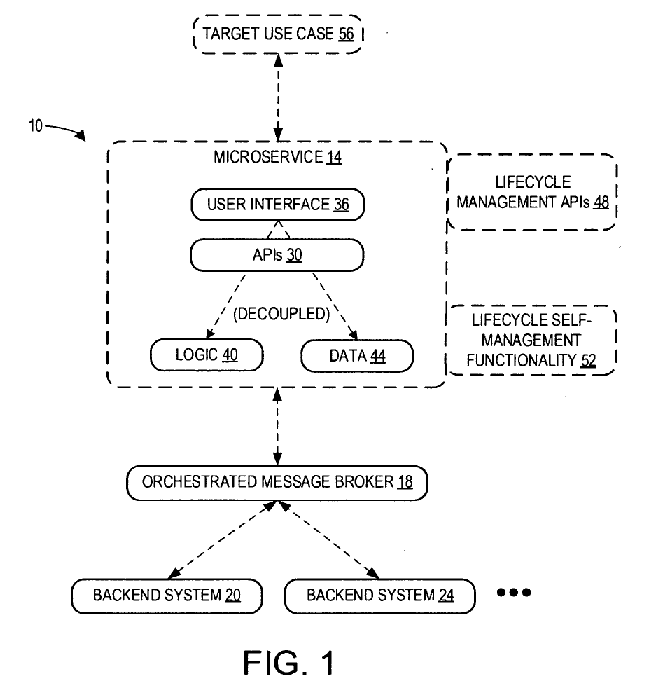

With reference now to FIG. 1, a schematic diagram of an example system 10 including a microservice 14, orchestrated message broker 18, and backend systems 20, 24 according to examples of the present disclosure is provided. In some examples the microservice 14 comprises API(s) 30 exposed by the microservice to other entities, a user interface (UI) 36, logic 40, and data 44 received from backend systems 20, 24. As described in more detail below, the UI 36, logic 40 and data may be decomposed into modules that may be shared with a different microservice. “Decomposing” an entity may be defined as breaking down the entity into lower level, more detailed components. Additionally, the microservice may include lifecycle management APIs 48 and/or may provide lifecycle self-management functionality 52. In this manner, the microservice 14 may expose a set of functions that are sufficient to support a target use case 56 and lifecycle management of the microservice.

In some examples, the UI 36 and APIs 30 are decoupled from the logic 40 and the backend systems 20, 24 by the orchestrated message broker 18. In this manner and utilizing APIs 30, in some examples the UI 36 may be geographically separated from the location where logic 40 and/or other resources are implemented, and/or from where sources of data 44 are located. In some examples and as described in more detail below, this arrangement may allow changing where data is processed or where functions are performed in a microservice without modifying the way that use cases using these functions are implemented. In some examples, such an arrangement may resolve issues associated with performing tasks outside of a data center, domain or country. Such an arrangement may address issues related to requirements for data to remain in a data center. For example, a country's regulatory requirements may mandate that billing records or user information may not leave the country, which may prevent such data from being processed in another country.

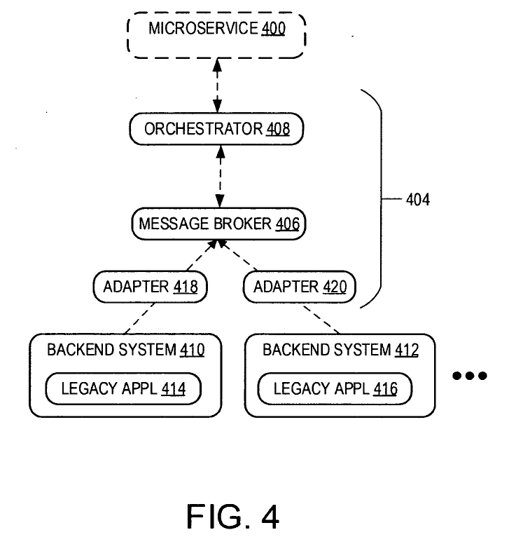

In some examples, the orchestrated message broker 18 may comprise an integration framework that is able to integrate applications in a flexible manner and orchestrate execution of workflows. As described in more detail below, in some examples a microservice may utilize an orchestrated message broker that comprises a message broker between an orchestrator and backend systems. Adapters may be interposed between applications of the backend systems and the message broker. Additional descriptions of an orchestrated message broker comprising a message broker between an orchestrator and backend systems are provided below with respect to FIG. 4. In other examples, an integration framework may comprise an Enterprise Service Bus framework and a Schools Interoperability Framework, and may not utilize a message broker.

In some examples, the microservice may be built automatically decoupled by utilizing an orchestrated message broker. In other examples, and instead of utilizing an orchestrated message broker, a composition of an API mashup or a UI mashup may be utilized to provide decoupling as described herein.

The orchestrated message broker 18 may perform an orchestrated execution of an end-to-end process via interactions of the backend systems 20, 24. While the example of FIG. 1 shows two backend systems 20, 24, other examples may include any number of backend systems. The orchestrated message broker 18 may be implemented as a combination of machine-executable instructions and processing hardware, such as a processor, a processor core, an application-specific integrated circuit (ASIC) device, a programmable gate array, and so forth. In other examples, the orchestrated message broker 18 may be implemented with processing hardware.

The orchestrated message broker 18 may be used to orchestrate the execution of a specific workflow that involves tasks performed by multiple applications of the backend systems 20, 24. To perform a workflow, logic 40 may be loaded into and executed by the orchestrated message broker 18. In some examples the orchestrated message broker 18 may execute multiple logic to perform respective workflows. In this manner, multiple workflows and workflow instances (instances of a particular workflow refer to multiple instantiations of the particular workflow) may be concurrently executed in parallel by the orchestrated message broker 18. The orchestrated message broker 18 is able to evaluate (interpret or execute) logic 40, and perform tasks specified by the logic in response to a current state of the workflow and calls and events received by the orchestrated message broker.

In some examples the orchestrated message broker 18 may provide for a multi-point orchestrated integration across multiple applications. In other examples, microservices according to the present disclosure may be implemented over other, different stacks and may interact with other SOA platforms and models, including but not limited to Enterprise Service Bus, Orchestration, Composition, and Publish/Discover/Bind.

As noted above, in the system 10 of FIG. 1 the APIs 30 and UI 36 are decoupled from the logic 40 and the backend systems 20, 24. In this manner, the system 10 may perform a function or implement the UI 36 by a particular function that can be realized in a plurality of different ways without changing the APIs 30 or UI 36. In the present disclosure, “decoupled” may be defined as entities (such as layers or components) interacting with each other through an integration framework that makes each entity independent of the location and type of other entities, provided that through the integration layer the same function or data processing is presented to the requesting entity. For example, decoupling may occur when a dependent class contains a pointer to an interface, which can then be implemented by one or many concrete classes. On the other hand and in contrast to decoupled entities, tight coupling may occur when a dependent class contains a pointer directly to a concrete class that provides the requested behavior. With tight coupling, changes to one object in a tightly coupled application often result in changes to a number of other objects that are interdependent with the changed object.

In the present disclosure and as described in more detail below, decoupling the UI 36 and API(s) 30 from the logic 40 and backend systems 20, 24 enables the microservice 14 to provide a particular function by utilizing an existing application, such as an application of backend system 20, or by utilizing another application associated with a different backend system, such as backend system 24. Further, and because the UI 36 and API(s) 30 are decoupled from logic 40, the same function may be provided by different applications/backend systems without modifying the UI 36.

In this manner, for example, an operation may be performed on data 44 or on integrated/repurposed applications that may be located close to the location of the UI 36 and API(s) of a microservice (such as in the same server, same data center, and/or same cloud configuration) or on data or repurposed/integrated applications located remotely from the UI and API(s) (in a different server, data center and/or cloud configuration), without appearing to modify the UI from the perspective of a user of the UI. That is, utilizing decoupling in microservice 14 as described above enables changing the location of data 44 and/or the location where processing of logic 40 occurs, while also maintaining the UI 36 substantially unchanged from the perspective of a user of the microservice 14. In some examples, this allows sources of data 44 and logic 40 to be geographically decoupled and separated. In some examples, logic and data may be separated by country, such as logic located in one country and data located in another, thereby enabling data to stay in the country. In some examples, logic may reside in one data center and data may reside in another data center without leaving that data center.

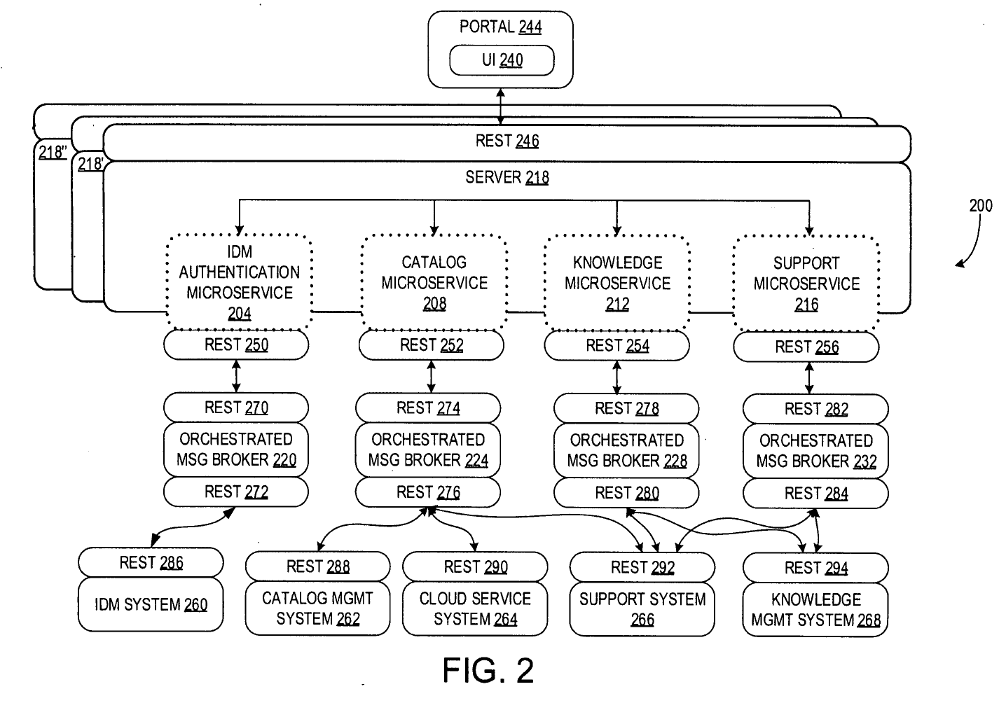

With reference now to the example of FIG. 2, an example arrangement including a plurality of microservices and backend systems that comprise a macro-application ecosystem 200 is provided. In this example, an identity management (IDM) microservice 204, catalog microservice 208, knowledge microservice 212 and support microservice 216 are provided. Each of these microservices may be implementations of microservice 14 described above. In some examples, each of these microservices may be implemented via a microservices server 218. In other examples, a microservice may be implemented via another server, such as server 218′, 218″, etc. Although example microservices are shown in FIG. 2, additional and/or other microservices may be provided in the microservices server 218 and on other servers.

The IDM authentication microservice 204 may perform authentication for a respective service. The catalog microservice 208 may perform a service related to an aggregate catalog, such as aggregating individual catalogs into an aggregate catalog. The knowledge microservice 212 may manage a knowledge base. The support microservice 216 may perform various support tasks.

The microservices 204, 208, 212, and 216 may interact with backend systems to execute an end-to-end process that is associated with a workflow, such as a target use case. In the present example and to execute the end-to-end process, the microservices 204, 208, 212, and 216 may be developed over orchestrated message brokers 220, 224, 228, and 232, respectively. Each orchestrated message broker may perform an orchestrated execution of an end-to-end process (workflow) implemented by its respective microservice. The orchestrated execution of the end-to-end process may include delegation of tasks to applications and/or to services (e.g. SaaS service, etc.) of a remote system, such as a backend system (e.g. cloud system, etc.).

In some examples such orchestrated execution may be performed in response to a request made via a UI 240 in a portal 244. The portal 244 may include machine-executable instructions or a combination of machine-executable instructions and processing hardware. The portal 244 may be at a computer (e.g. client computer) that may be remote from the microservice server 218 and other microservice servers, and may interface with the server(s) via a REST API 246. The UI 240 enables a user to interact with the microservices.

The microservices 204, 208, 212, and 216 may send respective requests over corresponding REST APIs 250, 252, 254, and 256 to respective orchestrated message brokers 220, 224, 228, and 232. While multiple orchestrated message brokers are shown in FIG. 2 for corresponding microservices, it is noted that in other examples multiple microservices may utilize the same orchestrated message broker. Each orchestrated message broker 220, 224, 228, and 232 may orchestrate execution of respective workflows using backend systems, which in this example may include an identity management (IDM) system 260, a catalog management system 262, a cloud service system 264, a support system 266, and a knowledge management system 268. Each of the systems 260, 262, 264, 266, and 268 can include respective applications or services.

Each orchestrated message broker 220, 224, 228, and 232 also may include corresponding REST APIs 270/272, 274/276, 278/280, and 282/284. Similarly, each of the systems 260, 262, 264, 266, and 268 can include corresponding REST APIs 286, 288, 290, 292, and 294.

As noted above, each of the microservices 204, 208, 212, and 216 may be implementations of microservice 14. Accordingly and because the logic and data of each microservice are decoupled from the corresponding UI and REST API, the user interface, logic and data (e.g., components) of one microservice may be decomposed into modules that may be shared with a different microservice. Additionally and in this example, lifecycle management may be provided by the environment. If a microservice is to be scaled or restarted, such operation may be performed manually or automatically by the system at the microservice or at a microservice layer level. In some examples, a microservice may be developed to perform such operations itself via lifecycle self-management functionality. In these examples, systems and/or services may self-discover and load balance/route as needed.

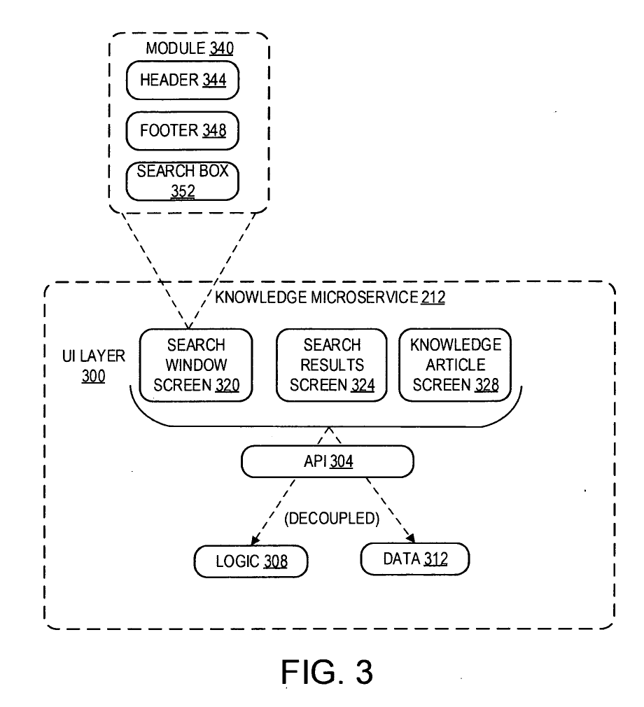

In one example and with reference now to FIG. 3, the knowledge microservice 212 may comprise a UI layer 300 and API 304 that are decoupled from logic 308 and data 312. In this example, the UI layer 300 may be decomposed into various modules or screens, such as a search window screen 320, a search results screen 324, and a knowledge article screen 328.

In some examples where a user inputs a search request via the search window screen 320, logic 308 may implement the search by accessing data 312. The data 312 may or may not be resident in the knowledge microservice 212. For example, data 312 may be located on a backend system, such as the knowledge management system 268.

In some examples, a screen/module of the UI layer 300 may be decomposed further into elements that also may be shared with another microservice(s). In this manner and in one example, an element of a module in the knowledge microservice 212 may communicate with a first logical endpoint of this microservice, and may also communicate with a different logical endpoint of a different microservice. In some examples, decomposing modules into smaller pieces may allow and facilitate innovation within a particular domain, which enables developers to focus on details and smaller aspects within that domain. Additionally, such an architecture may reduce interdependencies between developers writing different capabilities, thereby enabling a globally disparate team to quicken development.

For example and with continued reference to FIG. 3, the search window screen 320 may comprise a module 340 that may be decomposed further into elements comprising a header 344, footer 348 and search box 352. Because the UI layer 300 is decoupled from logic 308 and data 312, the UI of knowledge microservice 212 is not strictly tied to specific logic associated with this microservice. For example, the search box 352 is not strictly dependent upon a specific knowledge microservice logic for proper and complete functionality. Accordingly, the search box may communicate with a logical endpoint of the knowledge microservice 212, and may also communicate with a logical endpoint of another microservice, such as the support microservice 216, catalog microservice 208, and/or IDM authentication microservice 204. Additionally and in some examples, a module may be scaled and layers of the module may be scaled.

In this manner, utilizing microservices according to the present disclosure may avoid duplicating code for each microservice. For example, without decoupling and the ability to decompose modules and elements as described above, separate code for a search results box for each microservice may be needed, with each instance being customized. In other words, if a microservice is tightly coupled to a backend system, significant duplicate code may be needed.

In the present disclosure, one microservice may easily interact with several other microservices. For example and with reference to FIG. 2, the support microservice 216 may rely on functionality provided by the knowledge microservice 212, capabilities from the catalog microservice 208, and authentication services provided by the IDM microservice 204 to provide the business value of a target use case. Further, in some examples the support microservice 216 may not store support tickets locally, or locally create or track data associated with a support request. Instead, the support microservice 216 may utilize the orchestrated message broker 232 to decouple from backend systems that provide these services (in this example, support system 266 and knowledge management system 268).

In this manner, a backend system may be easily replaced with another backend system while maintaining a consistent UI experience for a user of the microservice. In other words, where a first backend system executes a function exposed by the microservice, this first backend system may be replaced with a second, different backend system while the function remains substantially unchanged. For example, the support system 266 may comprise an IT service desk solution in the form of a software suite that utilizes a consistent set of processes to handle service delivery and support. In some examples, this support system 266 may be replaced with a different support system, such as a cloud-based service desk solution, while maintaining both a consistent UI experience via UI 240 and business value provided by support system 266. Accordingly and by utilizing an orchestrated message broker as described above, a microservice may be easily and flexible modified by replacing or updated backend systems.

In some examples, the configurations described above may be utilized to enable use of existing legacy applications of a backend system to contribute to a microservice by generating new applications. In some examples, an existing application of a backend system may not have been designed for use with a microservice. With reference now to FIG. 4, in some examples a microservice 400 according to the present disclosure may utilize an orchestrated message broker 404 that comprises a message broker 406 between an orchestrator 408 and backend systems 410 and 412 that include legacy application(s) 414 and 416, respectively. Adapters 418 and 420 may be interposed between applications of the backend systems 410, 412 and the message broker 406.

Each of the orchestrator 408, message broker 406, and adapters 418, 420 may be implemented as a combination of machine-executable instructions and processing hardware, such as a processor, a processor core, an application-specific integrated circuit (ASIC) device, a programmable gate array, and so forth. In other examples, any of the orchestrator 408, message broker 406, and adapters 418, 420 may be implemented with processing hardware.

The message broker 406 may be utilized to exchange messages among components, including the orchestrator 408 and the adapters 418, 420. A message can include any or some combination of a call (e.g. API call) or an event (e.g. response, result, or other type of event). The message broker 406 is responsible for ensuring that API calls and events (e.g. responses, results, etc.) are sent to the correct adapter or to the correct workflow instance, as multiple workflow instances may execute concurrently. In some examples, the endpoints (adapters and workflow instances) may each receive a call or event and may make a decision regarding whether each endpoint should process the call or event.

The adapters 418, 420 may perform protocol translations between the protocol of an API of the message broker 406, and the protocols to which the interfaces exposed by the corresponding applications are bound. As an example, the protocol of an abstract API of the message broker 406 may be according to a REST protocol or other suitable protocol. The protocol of an interface exposed by a legacy application 414, 416 may include Simple Object Access Protocol (SOAP), Remote Procedure Call (RPC), Session Initiation Protocol (SIP), and so forth. Each adapter 418, 420 also may transform the data model of a message (e.g. message carrying an event), an abstract API call to the data model, and a specific API call exposed by a particular application (e.g. instance or release of the particular application). That is, an adapter may perform interface adaptation or interface translation by converting the abstract message or abstract API to a message or API call that conforms to the API of the target application.

In some examples, a front end API or widget also may be connected to the orchestrator 408. Utilizing this example arrangement, a legacy application may be managed via tools, such as Hewlett-Packard's Cloud Service Automation and/or Operations Orchestration tools, with content to provision and manage the application. In this manner, new services may be built using older, legacy applications, and enterprises may deploy new services that utilize some functions that duplicate existing legacy applications. In other words, microservices built according to the present disclosure may enable a legacy application to be repurposed by exposing at least a portion of the application's capabilities through a functional interface. In some examples, microservices built according to the present disclosure may allow developers to repurpose legacy applications in different contexts, such as utilizing incorporating an updated UI, reusing functionality in a new application, service or process, or using a microservice in a cloud environment.

In some examples, such legacy applications may be repurposed by limiting the functionality that is exposed to functionality having those properties that are proper for a microservices system according to the present disclosure. For example, a legacy application may lack an API and/or may have function(s) that are not amenable to a microservices implementation according to the present disclosure. However, by exposing other functionality that is amendable to a microservices implementation, and by utilizing an orchestrated message broker as described above, a microservice may be created or enhanced through repurposing this application. In this manner, the life span of legacy applications may be increased and existing IT investments may be protected.

In some examples, creating and utilizing microservices according to the present disclosure may enable development of reactive and resilient architectures that may be rapidly scaled and easily managed and modified to achieve a target performance and use case(s). That is, utilizing microservices according to the present disclosure may enable a developer to recompose even the same set of services in different ways by orchestrating the services differently to provide different business value. Additionally, new applications may be composed from existing microservices.

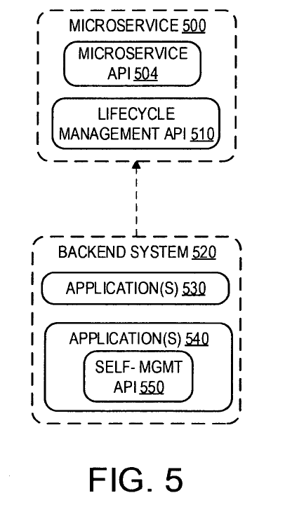

With reference now to the arrangement shown in FIG. 5, in some examples a microservice 500 according to the present disclosure may comprise a microservice API 504 (such as a REST API as described above) and at least one lifecycle management API 510 through which external lifecycle management may be performed on the microservice and/or at least one backend system 520. In some examples the lifecycle management API 510 may be exposed by logic of the microservice 500. In this manner, configurations of the present disclosure may enable the external coordination and control of application(s) 530 of the backend system 520, such as applications that utilize transaction persistence, auditing and/or higher security measures, for example. Additionally, these configurations may allow for application-level (as opposed to container-level) management in a large and diverse environment.

In some examples, such as for microservices comprising disposable services without internal persistence, a backend system may comprise application(s) 540 that perform self-management (for example, utilize feedback to determine performance, alter application requirements, and generate alerts if needed). In this manner, self-management allows the application to determine the need to perform application management tasks, and to perform such tasks itself (such as automated scaling when needed, automated remediation, automated discovery of other needed services when restarted or duplicated, etc.). In these examples a self-management API 550, coupled with dynamic injection and loading of middleware, may enable more autonomous macro-applications.

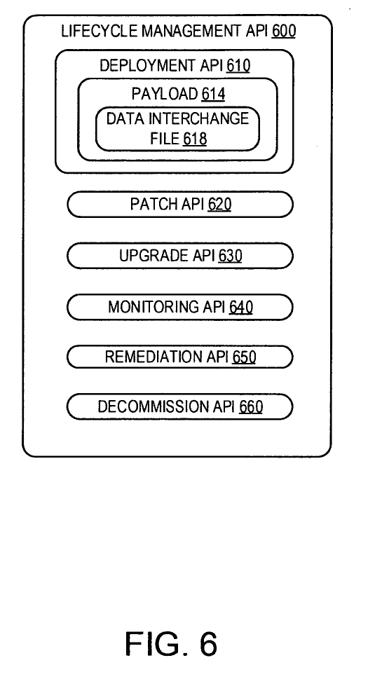

With reference now to FIG. 6, a schematic diagram of an example lifecycle management API 600 of an application forming a portion of a microservice according to the present disclosure is provided. In this example, the lifecycle management API 600 comprises a deployment API 610 that describes how the microservice is started, stopped, and deployed. In some examples, the contents of the deployment API 610 are served with the application package, as the contents of the API payload 614 need to be delivered before the application is actually deployed.

Such contents may be defined in a data interchange file 618, such as a JSON file, that is packaged with the service module. In some examples the service module specification may be defined in a lifecycle JSON file that will be a validated component of each microservice. As a given microservice provides business value when deployed with other microservices, the deployment API 610 may define the dependencies of the application upon which it may interact. Such interfaces may be loosely coupled and connected using dynamic DNS to resolve end-points and ports. In this manner, a generic deployment API 610 may be utilized in specific deployments without complex and lengthy installation and configuration.

The lifecycle management API 600 may further comprise a patch API 620 and an upgrade API 630. The patch API 620 is a runtime interface that is defined by its ability to perform live, runtime changes to the application. This is different from the upgrade API 630, described in more detail below, as the patch API 620 will revision the semantic version of the service solely at a minor-minor level. In some examples, the patch API 620 may be defined in a RESTful API Modeling Language (RAML) document, and may be implemented via a functional HTTP interface.

The patch API 620 may accept a list of runtime-dependency changes for the service. The service then accepts these dependency changes and injects them at runtime to replace the existing dependency references. In this manner, rapid and small changes to a given service are enabled without downtime or large API changes.

The upgrade API 630 also allows for changes to the application, but may include data model adjustments, changes in the location or type of persistence for a given service, or a redeployment of the application. Like the patch API 620, the upgrade API 630 may be defined in a RAML document and may be implemented via a functional HTTP interface. The mechanism of the upgrade API 630 is similar in that a set of dependencies is sent to the interface, and the service resolves and sets up the dependencies. With the upgrade API 630, the potential impact to the target service or interconnected services is higher than with the patch API 620. As such, the upgrade API 630 also may send upgrade notifications to all of the microservices interconnected with the application.

The monitoring API 640 may monitor and collect metrics related to the performance, security, usage, compliance, event and incident processing (such as event/incident handling or prediction), and other characteristics of the microservice. For example, the microservice may call the underlying deployment environment to set up monitoring. The remediation API 650 may perform various management operations with respect to the microservice, such as duplication, moving, terminating, changing settings, scaling up or out, and scaling down or in. The lifecycle management API 600 may further comprise a decommission API 660. In enterprise environments where a loss of records may have significant consequences, a decommissioning process in an application lifecycle may be useful. The decommission API 660 may define a decommissioning process for a service in which data related to the service is aggregated sent to an archiving service. The archiving service may be defined by the deployment API 610 as an interconnected service in the microservice ecosystem. The decommission API 660 may be defined in a RAML document and may be implemented via a functional HTTP interface.

Each of the deployment API 610, patch API 620, upgrade API 630, monitoring API 640, remediation API 650,-and decommission API 660 interfaces may be implemented on each microservice in a macro-application ecosystem, such as the example ecosystem 200 illustrated in FIG. 2. In this manner, application-level management, as opposed to container-level management, may be provided in large and diverse environments. Performing such management of a microservice and/or related applications may include appropriate subsequent routing or discovery of microservice updates after management operations are performed externally or via lifecycle self-management.

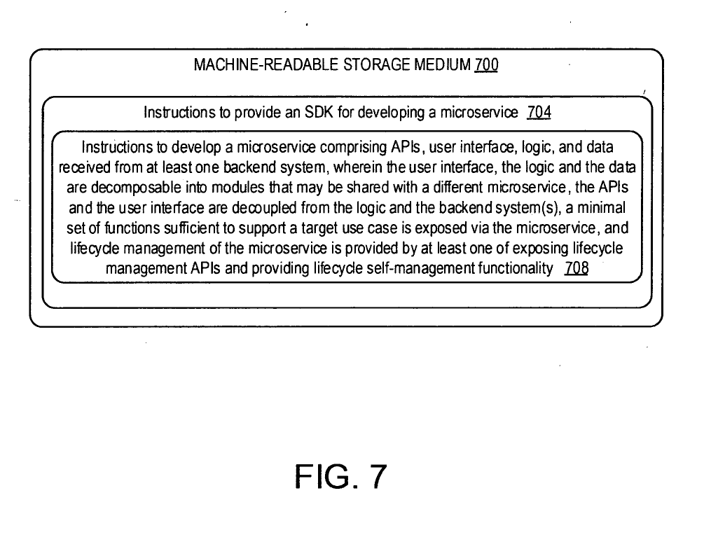

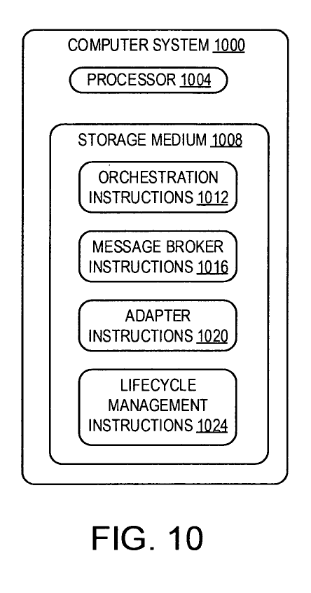

With reference now to FIG. 7, a block diagram of a non-transitory machine-readable storage medium 700 containing instructions to provide a software development kit (SDK) for developing a microservice according to an example of the present disclosure is provided. When executed by at least one processor, such as processor 1004 of computer system 1000 shown in FIG. 10 and described in more detail below, such instructions may provide an SDK for developing a microservice consistent with the following example and other examples described herein.

In some examples, the SDK provided by the non-transitory machine-readable storage medium 700 may comprise tools for developing microservices according to the present disclosure. In some examples, a developer may use the SDK and corresponding tools to develop a microservice, to develop an application as a composition of microservices, and/or to repurpose existing application(s) or system(s) into microservices according to the present disclosure. For example, a developer may utilize the SDK to develop a UI, APIs, the integration to logic/data (orchestration, adapters), etc., according to examples described herein. In some examples the SDK may comprise tools that may be executed locally on a developer computing system, or executed remotely as, for example, web-based tools. The SDK may be based in any suitable integrated development environment, such as, for example, an Eclipse IDE. In this manner, the SDK may enable developers to develop microservices according to the patterns and principles of the present disclosure.

In the example of FIG. 7, at 704 the instructions of non-transitory machine-readable storage medium 700 may include instructions to provide an SDK for developing a microservice. At 708 the instructions to provide the SDK may comprise instructions to develop a microservice comprising application programming interfaces (APIs), a user interface, logic, and data received from at least one backend system, wherein the user interface, the logic and the data are decomposable into modules that may be shared with a different microservice, the APIs and the user interface are decoupled from the logic and the backend system(s), a minimal set of functions sufficient to support a target use case is exposed via the microservice, and lifecycle management of the microservice is provided by at least one of exposing lifecycle management APIs and providing lifecycle self-management functionality.

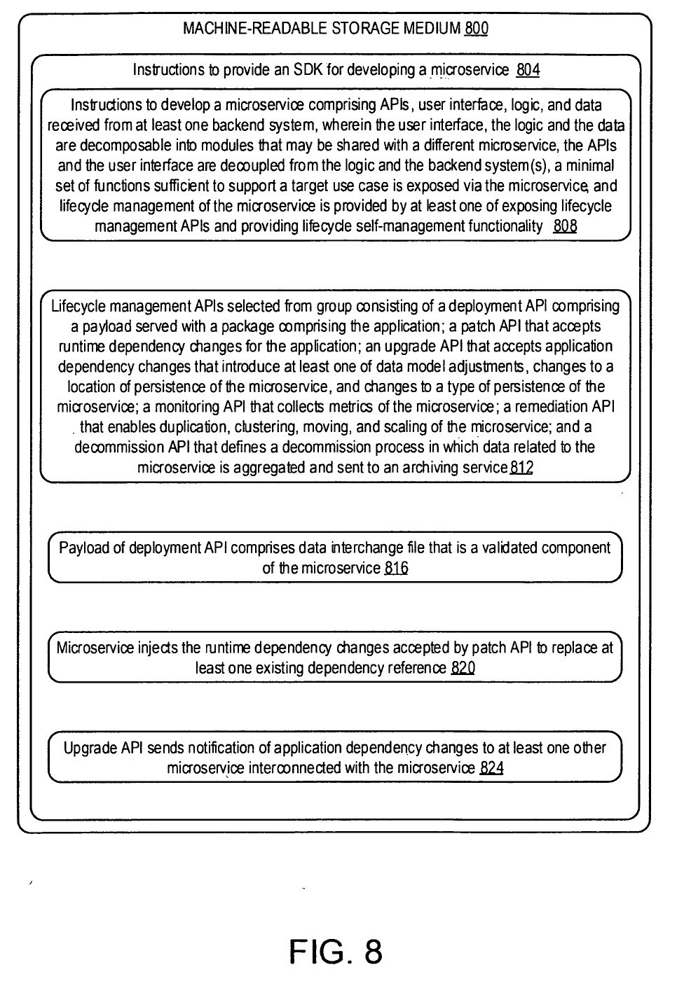

With reference now to FIG. 8, a block diagram of another non-transitory machine-readable storage medium 800 containing instructions to provide a software development kit (SDK) for developing a microservice according to an example of the present disclosure is provided. When executed by at least one processor, such as processor 1004 of computer system 1000 shown in FIG. 10, such instructions may provide an SDK for developing a microservice consistent with the following example and other examples described herein.

In some examples and as described above with respect to the example non-transitory machine-readable storage medium 700, the SDK provided by the non-transitory machine-readable storage medium 800 may comprise tools for developing microservices according to the present disclosure. In this manner, the SDK may enable developers to develop microservices according to the patterns and principles of the present disclosure.

In the example of FIG. 8, and as described in more detail below, the instructions of non-transitory machine-readable storage medium 800 may include instructions to, at 804, provide an SDK for developing a microservice. At 808 the instructions to provide the SDK may comprise instructions to develop a microservice comprising application programming interfaces (APIs), a user interface, logic, and data received from at least one backend system, wherein the user interface, the logic and the data are decomposable into modules that may be shared with a different microservice, the APIs and the user interface are decoupled from the logic and the backend system(s), a minimal set of functions sufficient to support a target use case is exposed via the microservice, and consistent lifecycle management of the microservice is provided by at least one of exposing lifecycle management APIs and providing lifecycle self-management functionality.

At 812 the lifecycle management APIs may be selected from the group consisting of a deployment API comprising a payload served with a package comprising the application; a patch API that accepts runtime dependency changes for the application; an upgrade API that accepts application dependency changes that introduce at least one of data model adjustments, changes to a location of persistence of the microservice, and changes to a type of persistence of the microservice; a monitoring API that collects metrics of the microservice; a remediation API that enables duplication, clustering, moving, and scaling of the microservice; and a decommission API that defines a decommission process in which data related to the microservice is aggregated and sent to an archiving service.

At 816 the lifecycle management APIs may comprise the deployment API, and the payload may comprise a data interchange file that is a validated component of the microservice. At 820 the lifecycle management APIs may comprise the patch API, and the microservice may inject the runtime dependency changes to replace at least one existing dependency reference. At 824 the lifecycle management APIs may comprise the upgrade API that sends a notification of the application dependency changes to at least one other microservice interconnected with the microservice.

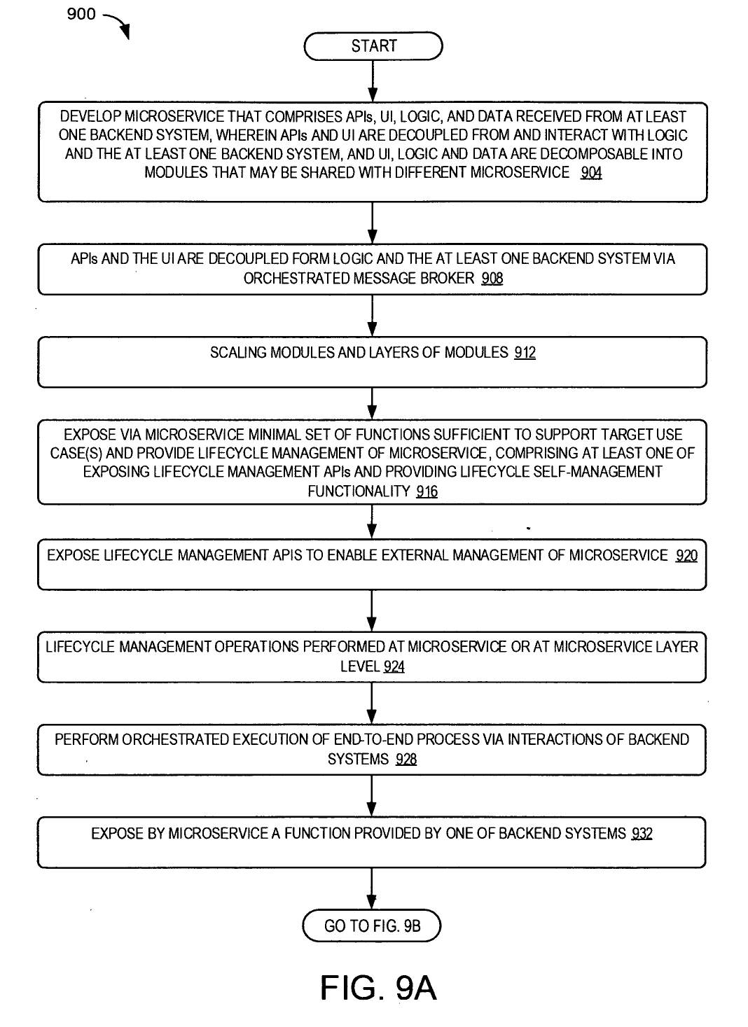

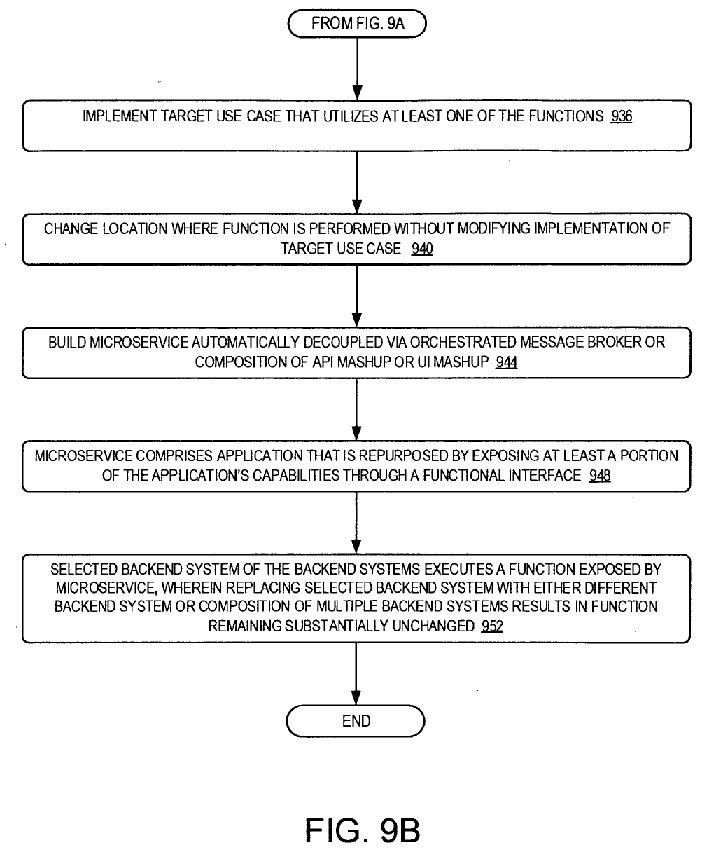

With reference now to FIG. 9A, a flow chart of a method 900 for developing a microservice is provided. The following description of method 900 is provided with reference to the software and hardware components described above and shown in FIGS. 1-8. The method 900 may be executed in the form of instructions encoded on a non-transitory machine-readable storage medium that is executable by a processor. It will be appreciated that method 900 may also be performed in other contexts using other suitable hardware and software components.

With reference to FIG. 9A, at 904 the method 900 may include developing a microservice that comprises application programming interfaces (APIs), a user interface, logic, and data received from at least one backend system, wherein the APIs and the user interface are decoupled from and interact with the logic and the at least one backend system, and the user interface, the logic and the data are decomposable into modules that may be shared with a different microservice. At 908 the APIs and the user interface may be decoupled from the logic and the at least one backend system via an orchestrated message broker. At 912 the method 900 may include scaling the modules and layers of the modules.

At 916 the method 900 may include exposing via the microservice a minimal set of functions sufficient to support a target use case and to provide consistent lifecycle management of the microservice, comprising at least one of exposing lifecycle management APIs and providing lifecycle self-management functionality. At 920 the method 900 may include exposing the lifecycle management APIs to enable external management of the microservice. At 924 the lifecycle management operations may be performed at the microservice or at a microservice layer level. At 928 the method 800 may include performing an orchestrated execution of an end-to-end process via interactions of the backend systems.

At 932 the method 900 may include exposing by the microservice a function provided by one of the backend systems. With reference now to FIG. 9B, at 936 the method 900 may include implementing the target use case that utilizes at least one of the functions. At 940 the method 900 may include changing a location where the function is performed without modifying the implementation of the target use case. At 944 the method 900 may include building the microservice automatically decoupled via an orchestrated message broker or a composition of an API mashup or a UI mashup.

At 948 the microservice may comprise an application that is repurposed by exposing at least a portion of the application's capabilities through a functional interface. At 952 a selected backend system of the backend systems may execute a function exposed by the microservice, and replacing the selected backend system with either a different backend system or composition of multiple backend systems may result in the function remaining substantially unchanged.

It will be appreciated that method 900 is provided by way of example and is not meant to be limiting. Therefore, it is to be understood that method 900 may include additional and/or other elements than those illustrated in FIGS. 9A and 9B. Further, it is to be understood that method 900 may be performed in any suitable order. Further still, it is to be understood that at least one element may be omitted from method 900 without departing from the scope of this disclosure.

FIG. 10 shows a block diagram of an example computer system 1000 that may be utilized to implement microservices and other examples of the present disclosure. The computer system 1000 may include one computer or multiple computers coupled over a network. The computer system 1000 comprises a processor (or multiple processors) 1004. The processor(s) 1004 may include at least one physical device to execute at least one instruction. Additionally or instead, the processor(s) 1004 may include hardware logic circuit(s) or firmware device(s) to execute hardware-implemented logic or firmware instructions. Processor(s) 1004 may be single-core or multi-core, and the instructions executed thereon may be for sequential, parallel, and/or distributed processing.

In some examples, individual components of the processor(s) 1004 may be distributed among two or more separate devices, which may be remotely located and/or for coordinated processing. Aspects of the processor(s) may be virtualized and executed by remotely accessible, networked computing devices in a cloud-computing configuration. In such a case, these virtualized aspects may be run on different physical logic processors of various different machines.

Processor(s) 1004 may be to execute instructions that are stored on a non-transitory machine-readable storage medium. Such instructions may be part of at least one application, service, program, routine, library, object, component, data structure, or other logical construct. Such instructions may be implemented to perform a task, implement a data type, transform the state of at least one device, or otherwise arrive at a result.

The processor(s) 1004 may be coupled to a non-transitory machine-readable or computer-readable storage medium 1008, which may store various machine-executable instructions. The machine-executable instructions may include orchestration instructions 1012 to implement an orchestrator, such as orchestrator 408 shown in FIG. 4, message broker instructions 1016 to implement a message broker, such as message broker 406 shown in FIG. 4, adapter instructions 1020 to implement adapters, such as adapters 418, 420 shown in FIG. 4, and lifecycle management instructions 1024 to implement lifecycle management functionality associated with self-management functionality and lifecycle management APIs, such as lifecycle management APIs 48 shown in FIG. 1.

The storage medium (or storage media) 1008 may include memory devices with at least one of the following characteristics: volatile, nonvolatile, dynamic, static, read/write, read-only, random access, sequential access, location addressable, file addressable, and content addressable. Non-volatile storage devices may comprise a physical device (or devices) to hold instructions executable by the processor(s) 1004 to implement the methods and processes described herein. Non-volatile storage devices may include physical devices that are removable and/or built-in. Non-volatile storage devices may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology.

In some examples, the processor(s) 1004 and storage medium 1008 may be components of at least one computing device. In different examples, such computing device may take the form of a server, network computing device, desktop computing device, and/or other suitable type of computing device.

1. A method, comprising:
developing a microservice that comprises application programming interfaces (APIs), a user interface, logic, and data received from at least one backend system, wherein the APIs and the user interface are decoupled from and interact with the logic and the at least one backend system, and the user interface, the logic and the data are decomposable into modules that may be shared with a different microservice; and
exposing via the microservice a minimal set of functions sufficient to support a target use case and to provide lifecycle management of the microservice, comprising at least one of exposing lifecycle management APIs and providing lifecycle self-management functionality.

2. The method of claim 1, comprising exposing the lifecycle management APIs to enable external management of the microservice.

3. The method of claim 1, wherein lifecycle management operations are performed at the microservice or at a microservice layer level.

4. The method of claim 1, comprising scaling the modules and layers of the modules.

5. The method of claim 1, comprising performing an orchestrated execution of an end-to-end process via interactions of the backend systems.

6. The method of claim 1, wherein the APIs and the user interface are decoupled from the logic and the at least one backend system via an orchestrated message broker.

7. The method of claim 1, comprising:
exposing by the microservice a function provided the at least one backend system;
implementing the target use case that utilizes at least one of the functions; and
changing a location where the function is performed without modifying the implementation of the target use case.

8. The method of claim 1, comprising building the microservice automatically decoupled via an orchestrated message broker or a composition of an API mashup or a UI mashup.

9. The method of claim 1, wherein the microservice comprises an application that is repurposed by exposing at least a portion of the application's capabilities through a functional interface.

10. The method of claim 1, wherein a selected backend system of the at least one backend system executes a function exposed by the microservice, and wherein replacing the selected backend system with either a different backend system or composition of multiple backend systems results in the function remaining substantially unchanged.

11. A system, comprising:
a microservice comprising application programming interfaces (APIs), a user interface, logic, and data received from backend systems, wherein the user interface, the logic and the data are decomposable into modules that may be shared with a different microservice, and the APIs and the user interface interact with the logic and the backend systems; and
an orchestrated message broker that is to decouple the APIs and the user interface from the logic and the backend systems;
wherein the microservice is to expose a minimal set of functions sufficient to support a target use case and to provide lifecycle management of the microservice, the lifecycle management comprising at least one of lifecycle self-management functionality and a lifecycle management API that is exposed to enable external lifecycle management of the microservice.

12. The system of claim 11, wherein an element of one of the modules may communicate with a first logical endpoint of the microservice and a different logical endpoint of the different microservice.

13. The system of claim 11, wherein the orchestrated message broker performs an orchestrated execution of an end-to-end process via interactions of the backend systems.

14. The system of claim 11, wherein the logic and the data are geographically separated.

15. The system of claim 11, wherein the backend systems comprise at least one of an identity management system, a support system, a cloud service system, a knowledge management system, and a catalog management system.

16. A non-transitory machine-readable storage medium encoded with instructions executable by a processor to provide a software development kit (SDK) for developing a microservice, the machine-readable storage medium comprising:
instructions to develop a microservice comprising application programming interfaces (APIs), a user interface, logic, and data received from at least one backend system, wherein the user interface, the logic and the data are decomposable into modules that may be shared with a different microservice, the APIs and the user interface are decoupled from the logic and the at least one backend system, a minimal set of functions sufficient to support a target use case is exposed via the microservice, and lifecycle management of the microservice is provided by at least one of exposing lifecycle management APIs and providing lifecycle self-management functionality.

17. The non-transitory machine-readable storage medium of claim 16, wherein the instructions to develop the microservice comprise instructions to provide lifecycle management by exposing the lifecycle management APIs of an application that forms a portion of the microservice, wherein the lifecycle management APIs are selected from the group consisting of a deployment API comprising a payload served with a package comprising the application; a patch API that accepts runtime dependency changes for the application; an upgrade API that accepts application dependency changes that introduce at least one of data model adjustments, changes to a location of persistence of the microservice, and changes to a type of persistence of the microservice; a monitoring API that collects metrics of the microservice; a remediation API that enables duplication, clustering, moving, and scaling of the microservice; and a decommission API that defines a decommission process in which data related to the microservice is aggregated and sent to an archiving service.

18. The non-transitory machine-readable storage medium of claim 17, wherein the lifecycle management APIs comprise the deployment API, and the payload comprises a data interchange file that is a validated component of the microservice.

19. The non-transitory machine-readable storage medium of claim 17, wherein the lifecycle management APIs comprise the patch API, and the microservice is to inject the runtime dependency changes to replace at least one existing dependency reference.

20. The non-transitory machine-readable storage medium of claim 17, wherein the lifecycle management APIs comprise the upgrade API that is to send a notification of the application dependency changes to at least one other microservice interconnected with the microservice.
